(19) United States
(12) Patent Application Publication
(10) Pub. No.: US 2015/0046266 A1
(43) Pub. Date: Feb. 12, 2015

(54) METHOD AND SYSTEM OF DETERMINING TARGETING DATA

(71) Applicant: ChaCha Search, Inc, Carmel, IN (US)

(72) Inventor: Eugene M. O'Donnell, Fishers, IN (US)

(73) Assignee: ChaCha Search, Inc, Carmel, IN (US)

(21) Appl. No.: 14/457,180

(22) Filed: Aug. 12, 2014

Related U.S. Application Data
(60) Provisional application No. 61/864,998, filed on Aug. 12, 2013.
(60) Provisional application No. 61/865,351, filed on Aug. 13, 2013.

(51) Int. Cl. G06Q 30/02

(52) U.S. Cl. CPC G06Q 30/0269
USPC 705/14.66

(57) ABSTRACT

A system and method for targeting of content is based on indirect gathering of information of users. Activities of a user are recorded and may be aggregated to determine a profile of a user. When a request for content which indicates a publisher is received, a profile of a user and/or a publisher is determined and used to target content to a user.

### BACKGROUND

1. Field of the Invention

The present invention is related to targeting of content and more specifically to targeting of content responsive to information distributed by affiliated publishers.

2. Description of the Related Art

In systems wherein content is distributed using social media content is directed to users who are “following” a particular person or group. Consequently the distributed content is targeted to the followers, who may be a heterogeneous group. Sponsored content may be distributed using systems such as Twitter's Sponsored Tweets, or MyLikes.

Social media distribution may be an effective method of obtaining user attention. Content distributed by a particular channel or by a specific publisher can be tracked based on a tracking URL which is assigned to a publisher and/or channel. In this way, a publisher may be compensated for a number of visitors directed to a website and/or other content by a publisher.

However, targeting sponsored content based on a publisher may have some weaknesses as well. For example, the same people may be following multiple publishers, which may be in competition with each other. Thus there may be oversaturation of a user because the same content has been provided by different channels. Likewise, it is not possible to target content to a user base associated with a profile such as geography, demography, etc.

For these and other reasons, a method and system for providing profile based targeting of content via social media would be greatly appreciated.

### SUMMARY

A system is implemented whereby content may be distributed to publishers. Content may be provided based on a ranking of the content for targeting parameters associated with a publisher. A system may provide identification data to a website. For example, a short text file or ‘cookie’ which identifies a particular website may be distributed to a number of websites. Based on websites which are visited by a user and/or user actions taken while visiting those websites, a usage profile of a user based on cookies may be created. When a user activates an indicator distributed by a publisher, such as a tracking URL, the user is directed to a server which counts the activation, records publisher information, and reviews the cookies associated with a user browser. Based on the profile associated with the user a profile associated with a publisher may be determined.

A publisher profile may be used in various ways. A publisher profile may be used to determine a ranking of sponsored content which is offered to a publisher. For example, if an advertiser wishes to target a location, demographic, or other attribute for which a publisher has a high ranking, the publisher may be more likely to be provided with sponsored content targeted to the advertiser profile. Compensation provided to a publisher may be determined based on profiles of users that respond to content. For example, if a content owner is targeting a location, visits by users who are associated with that location may be awarded a higher compensation than visits by users who are not. Content provided to a user may be affected by a profile of a user. For example, if an advertiser is interested in targeting different groups of users based on location, content targeted to a location may be provided to a user based on the profile of the user, rather than on a profile of an advertiser.

Additional aspects and/or advantages will be set forth in part in the description which follows and, in part, will be apparent from the description or may be learned by practice of the invention. These together with other aspects and advantages, which will be subsequently apparent, reside in the details of construction and operation as more fully hereinafter described, reference being had to the accompanying drawings forming a part hereof, wherein like numerals refer to like parts throughout.

### BRIEF DESCRIPTION OF THE DRAWINGS

Aspects and advantages of the disclosure will become apparent and more readily appreciated from the following description of the embodiments, taken in conjunction with the accompanying drawings, of which:

FIG. 1 is a block diagram of an exemplary system embodiment for distribution of content.

FIG. 2 is a flowchart of distributing content.

FIG. 3 is a block diagram of an exemplary system embodiment for creating a work.

FIG. 4 is a flowchart of creating content.

### DETAILED DESCRIPTION OF THE PREFERRED EMBODIMENTS

Reference will now be made in detail to the present embodiments discussed herein. Examples are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate. As used herein, words importing the singular shall include the plural and vice versa unless specifically counter indicated.

A system is provided which includes a user system for submitting a request and receiving a response, a distribution server receiving queries, and distributing information and/or content, a database storing information of users, websites, advertisers, publishers, and other information, a publisher system receiving information and publishing content, a website system receiving requests and providing responses and an advertiser system providing sponsored content and targeting information.

As used herein, a “request” means a request for information, products, and/or services. A request or query may include various types of media, and may be provided by any user system which may establish communication with a server and/or other devices accessible via a network such as the internet.

A “user” is a person who submits a request and may receive any type of information responsive to a request. A user may be any person or entity. A “publisher” is any person or entity which may distribute an indicator of content to a user. A publisher may distribute indicators such as a tracking URL or other code which may direct a user or other person to content which may be provided by a distribution system and/or an advertiser system. A publisher may publish using social media services from providers such as Twitter, Instagram, Facebook, etc.

An “advertiser” is any person and/or entity which may provide promotional information or “advertisements” to be delivered to a user. An advertisement may take various forms and/or may include media of any sort which can be delivered to a user device. A “website” may be any system which provides content responsive to a request. A website may be accessed using a browser functionality of a user device. An advertiser may provide content to a user. An advertiser may provide content to a publisher based on information obtained regarding users who have received content provided by a publisher. An advertiser may select a publisher based on a type of audience and a publishing channel made available by a publisher. A distribution system may track an activity of a publisher and may distribute content received from advertisers to a publisher based on information of users and content provided to users by a publisher. A distribution system may aggregate publishers in order to create an audience which is requested by an advertiser.

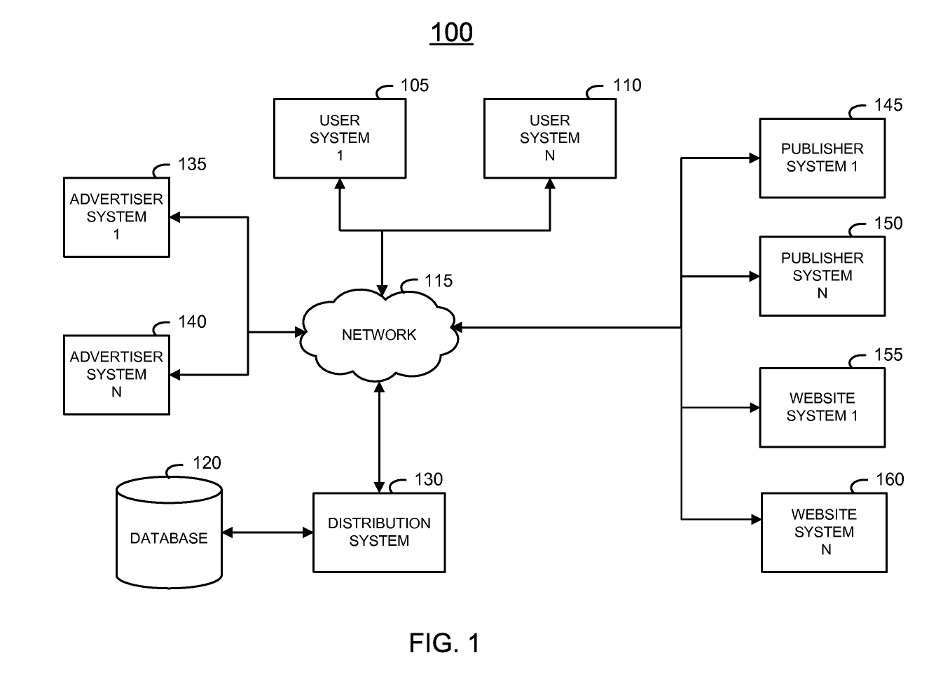

As illustrated in FIG. 1, system 100 includes user systems 105, 110, a network 115 such as the Internet, a distribution system 130, a database 120, which may comprise various records, advertiser systems 135, 140, publisher systems 145, 150, and website systems 155, 160.

While only a few systems associated with a user, a publisher, a website and an advertiser are depicted in FIG. 1 it is within the scope of the disclosure for multiple systems for a user, a publisher, a website and an advertiser to be utilized. In particular it is envisioned that many user, publisher, website and advertiser systems may be implemented. The distribution system 130 may be a composed of many components as described further herein.

The network 115 may be a global public network of networks (i.e., the Internet) and/or may consist in whole or in part of one or more private networks and communicatively couples the user systems 105, 110, the advertiser systems 135, 140, the publisher systems 145, 150 and the website systems 155, 160 with the other components of the system such as the distribution system 130, and the database 120. The network 115 may include one or more wireless networks which may enable wireless communication between the various elements of the system 100. For example, the distribution system 130 may receive messages which may be routed via a wireless network controlled by a wireless service to the user systems 105, 110. A wireless service may receive messages from the publisher systems 135, 140 via a wireless network which is a part of the network 115, and provide the messages to the distribution system 130 via an internet connection which is part of the network 115.

The distribution system 130 allows interaction to occur among the user systems 105, 110, the advertiser systems 135, 140, the publisher systems 145, 150 and the website systems 155, 160. For example, a request can be transmitted from the user system 105 to the distribution system 130, which may provide information obtained from the database 120, which may include an advertisement provided by the advertiser system 140 to the user system 105. Any type of communication between users, advertisers, websites and/or publishers may be mediated and/or facilitated by the distribution system 130, and/or other elements of the system 100.

The distribution system 130 is communicatively coupled with the database 120. As will be described herein in further detail below, the database 120 includes data that is processed in association with operation of the embodiments. Although FIG. 1 illustrates the database 120 as a separate component of the system, the database 120 may be integrated with the distribution system 130. Further, the records maintained in the database 120 may be stored in any typical manner, including in a Network Attached Storage (NAS), a Storage Area Network (SAN), RAID, etc., using any typical or proprietary database software such as DB2®, Informix®, Microsoft® SQLServer™, MySQL®, Oracle®, etc., and may also be a distributed database on more than one server. Elements of the database 120 may reside in any suitable elements of the system 100. Any or all elements of the system 100 may include any or the entirety of the database 120.

The user systems 105, 110, the advertiser systems 135, 140, the publisher systems 145, 150, the website systems 155, 160 and the distribution system 130 may include equipment, software, systems and personnel required to send and/or receive messages between a user system 105, 110, the advertiser systems 135, 140, the publisher systems 145, 150 the website systems 155, 160 and/or the distribution system 130 using the network 115. The database 120 includes information which may allow the distribution system 130 to establish communication between any or all of the elements of the system 100.

A user system, a publisher system, an advertiser system, a website system and/or a distribution system may be a desktop, portable, or tablet computer using an operating system such as Windows®, iOS®, Android®, etc., a mobile phone, a smart phone, a PDA, a server system, a landline phone, a specialized communication terminal, a terminal connected to a mainframe, or any other suitable communication hardware and/or system. The distribution system 130, an advertiser system, and/or a website system may include one or more servers, computers, etc. For example, servers such as the PowerEdge® 2900 by Dell, or the BladeCenterJS22 by IBM, or equivalent systems might be used to implement elements of the distribution system 130. The distribution system 130 may utilize an operating system (OS) such as Microsoft Windows XP, Linux, iOS®, Android®, etc. Voice routing and packet switching may be accomplished using well established technologies such as those provided by Cisco, or other networking companies. After being presented with the disclosure herein, one of ordinary skill in the relevant art will immediately realize that any viable computer systems or communication devices known in the art may be used as user systems, publisher systems, advertiser systems, website systems and/or to implement the distribution system 130.

A user may be identified by the distribution system 130. When a user system accesses the distribution system 130 data provided to systems such as the website systems 155, 160 and/or the advertiser systems 135, 140 may be obtained from a user system. Such data may not provide personally identifiable information of a user, but may indicate information regarding user interactions with a website system and/or an advertiser system.

A publisher may be required to register with the distribution system 130. As part of a registration process, at least one communication method is associated with a publisher. In at least one embodiment, a publisher may register with the distribution system 130 and establish a username and password which are associated with the publisher. A publisher may login to the distribution system 130 using a web browser functionality of the publisher system 145 in order to communicate with the distribution system 130. One or more identifiers may be assigned to a publisher which may be used to identify content associated with a publisher.

When a publisher is registered with the distribution system 130 the publisher may have access to content available from the distribution system 130. This may include sponsored content provided by the advertiser systems 135, 140. A publisher may distribute information which indicates content and an identifier assigned to a publisher to users. A publisher may be provided access to content based on a profile of a publisher and/or targeting information associated with content.

A website may be required to register with the distribution system 130. As part of a registration process, at least one communication method is associated with a website operator. In at least one embodiment, a website may register with the distribution system 130 and establish a username and password which are associated with the website. A website operator may login to the distribution system 130 using a web browser functionality of the website system 145 in order to communicate with the distribution system 130. One or more identifiers may be assigned to a website which may be used to distribute tracking information associated with a website.

When a website is registered with the distribution system 130 a website operator may have access to data available from the distribution system 130. This may include aggregated information of operators of user systems such as the user systems 105, 110. A website operator may provide aggregated user information to the distribution system 130 and/or may receive advertisements targeted based on targeting information provided by the distribution system 130.

An advertiser may be required to register with the distribution system 130. As part of a registration process, at least one communication method is associated with an advertiser. In at least one embodiment, an advertiser may register with the distribution system 130 and establish a username and password which are associated with the advertiser. An advertiser may login to the distribution system 130 using a web browser functionality of the advertiser system 145 in order to communicate with the distribution system 130. An advertiser system may provide content may associate targeting information with content.

When an advertiser is registered with the distribution system 130 an advertiser may have access to data available from the distribution system 130. This may include targeting information associated with publishers, use of advertisements, compensation associated with advertisements, targeting information, etc. An advertiser may target advertisements based on any available targeting parameters. An advertiser may provide content associated with a targeting parameter.

Records may be maintained in the database 120 which may be used to record the status of various items. Such records may be used to aid the targeting of content provided by advertisers, track activities of users, determine usage history of websites, publisher content, and advertisements, etc. For example, a user may activate an indicator distributed by a publisher, which may cause a request to be received by the distribution system 130, which may obtain website activity information which may be used to select content to be provided to a user responsive to a request.

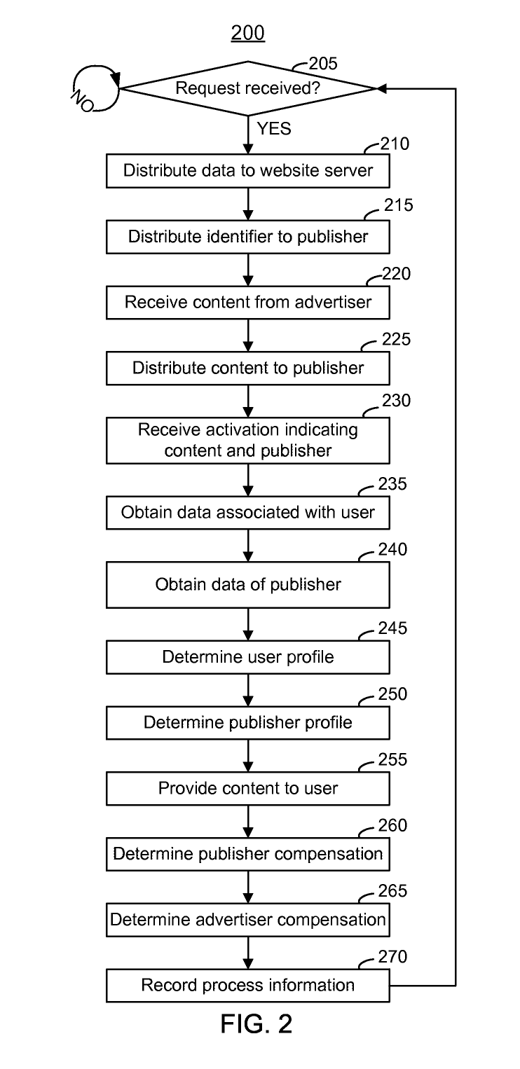

As illustrated in FIG. 2, a process 200 for providing targeted content is provided. The process 200 may be performed in whole or in part by any suitable element of the system 100 (FIG. 1). In at least one embodiment, the process 200 is operative on a server associated with the distributor system 130.

In operation 205 (FIG. 2) a determination is made as to whether a request is received. If it is determined in operation 205 that a request is not received, control remains at operation 205 and process 200 continues. If it is determined in operation 205 that a request is received, control is passed to operation 210 and process 200 continues.

The determination in operation 205 may be made using various criteria. In at least one embodiment, if a message is received at a system associated with the distribution system 130 (FIG. 1), it may be determined that a request is received. For example, if a GET request indicating an identifier of a publisher is received at a server associated with the distribution system 130, it may be determined that a request is received. Any type of message may be received which may indicate that a request is received.

In operation 210 data is distributed to a website server. Distribution of data to a website server may take place at any time. For example, a ‘cookie’ may be distributed to websites registered with the distribution system 130 when a website is registered, and may be updated based on factors such as time, usage, changes to website content, etc. A cookie, tracking pixel, etc., may be used to determine whether a user has visited a particular website. Control is passed to operation 215 and process 200 continues.

In operation 215 an identifier is distributed to a publisher. An identifier of a publisher may be distributed at any time. For example, a publisher may receive an identifier when a publisher elects to distribute content provided to a publisher by the distribution system 130. An identifier of a publisher may be used to determine that a user has been directed to content by a publisher. For example, a tracking URL associated with content may indicate to a provider of content that a user has been directed to the content by a publisher. Control is passed to operation 220 and process 200 continues.

In operation 220 content is received from an advertiser. Receipt of content from an advertiser may occur at any time. An advertiser may provide targeting information, a number of impressions desired, start and end dates, a bid for targeting information, an intended audience, compensation associated with content, etc. An advertiser may be a website operator. An advertiser may provide any type of media, which may be directed to an audience based on any or all targeting data for an audience. If more specific information of a user is available, a preference may be given to provide advertiser content to the user. Control is passed to operation 225 and process 200 continues.

In operation 225 content is distributed to a publisher. Content may be distributed to a publisher at any time. A publisher may be allowed to select content for distribution. A publisher may be presented with content based on a targeting profile associated with a publisher. A compensation associated with content may be determined for a publisher based on a targeting profile of a publisher and targeting information specified by an advertiser. For example, if users who have viewed content promoted by a publisher have been found to be associated with targeting data requested by a content provider, content from that provider may be preferentially directed to the publisher. Similarly an incentive to promote content may be increased for a publisher who has obtained page views associated with users meeting a target profile requested by an advertiser for content. Control is passed to operation 235 and process 200 continues.

In operation 230 an activation indicating content and a publisher is received. An activation may be any type of message which can be recognized by a processor. For example, a URL which requests information from a content server, a visit to a social media page, a peer-to-peer message, etc., may request content and identify a publisher associated with an activation. Content indicated by an activation and an identifier of a publisher may be obtained and/or provided responsive to an activation. Control is passed to operation 235 and process 200 continues.

In operation 235 data associated with a user is obtained. For example a cookie associated with a number of websites may be obtained from a browser functionality of a user device. Similarly, information associated with an identifier of a user which is shared between websites and a distribution system may be used to obtain related information of a user. Information such as an IP address, a device identifier, location data, etc., which may identify a user may be used to determine related information of a user. Historical information of websites, activities, etc., of a user may be obtained. Control is passed to operation 240 and process 200 continues.

In operation 240 data of a publisher is obtained. A profile associated with a publisher based on users who have activated an indicator of content distributed by a publisher may be obtained. For example information stored in the database 120 (FIG. 1) associated with a publisher may be retrieved. Information regarding content distributed by a publisher, compensation of a publisher, users associated with a publisher, frequency of distribution of content, audience size, etc. of a publisher may be obtained. Control is passed to operation 240 and process 200 continues.

In operation 245 a profile of a user is determined. A profile of a user may be determined based on data of a user obtained based on activity associated with a website system and/or an advertiser system. A profile of a user may be determined based on stored information of a user and/or information provided by a user explicitly and/or implicitly. For example, web form data and/or location data such as a subscriber ID number, GPS data, a social media profile, a social graph, content of postings, etc., may be used to determine a profile of a user. Control is passed to operation 250 and process 200 continues.

In operation 250 a profile of a publisher is determined. A profile of a publisher may be determined based on a profile of a user. A profile of a publisher may be determined based on aggregate data of users and activations associated with a set of targeting parameters which may be associated with content provided by a publisher. If activations of content distributed by a publisher are mainly received from users associated with a parameter, the parameter may have a higher rating for the publisher. For example, if activations originate from users associated with a geographic location, a publisher may have a higher targeting value for a geographic location. Similarly, parameters such as gender, age, ethnicity, preferences, and/or other characteristics of users may be assigned a rating for a publisher based on aggregated information of activations by users associated with content indicators distributed by a publisher. Control is passed to operation 255 and process 200 continues.

In operation 255, content is provided to a user. Content provided to a user may be based on an indicator which is activated by a user. Content provided to a user may be based on a profile of a user. If a user matches targeting parameters associated with content such as an advertisement, an advertisement may be provided to a user. For example, if a geographic location is associated with a user and an advertiser has designated various types of content to be provided responsive to a request, content which is ranked highest for a location may be provided to a user. Content available responsive to a request may be ranked based on a targeting profile of a user, and delivered to a user based on the ranking. Ranking of content may be influenced by a bid associated with content and an advertiser. For example, if no content which matches a user profile is found, unpaid content may be provided to a user. Control is passed to operation 260 and process 200 continues.

In operation 260, publisher compensation is determined. Compensation of a publisher may be determined based on various factors. If a user associated with a publisher is a close match to a targeting parameter specified by an advertiser, compensation of a provider may be increased. For example, if content is targeted to forty to fifty year-old men and a user is determined to be a forty-six year-old male, a publisher associated with an activation may receive higher compensation as intended targeting has been achieved. If a user is not associated with profile information, compensation of a publisher may be reduced. For example, if the system is unable to retrieve tracking cookies from a browser of a user associated with a request for content, compensation of a publisher associated with the user may be affected. If a user is associated with a different publisher, compensation of a publisher may be adjusted. For example, if a user has previously requested content based on activation of an indicator distributed by a first publisher if the user requests the same content based on activation of an indicator distributed by a second publisher, compensation of the second publisher and/or the first publisher may be affected. Control is passed to operation 265 and process 200 continues.

In operation 265, advertiser compensation is determined. Compensation of an advertiser may be determined based on various factors. If a user receiving content is a close match to a targeting parameter specified by an advertiser, compensation due from an advertiser may be increased. If a user is not associated with profile information, compensation due from an advertiser may be reduced. If a user is uniquely associated with a publisher, compensation of an advertiser may be adjusted. Temporal information may affect compensation due from an advertiser. Control is passed to operation 260 and process 200 continues.

In operation 270, process information is recorded. Information of a request or activation, a user, a publisher, a website, an advertiser, content, targeting parameters, user actions, compensation of a publisher, website, advertiser, etc., a rating, a ranking, etc. may be recorded. In at least one embodiment, process information is recorded in the database 120 (FIG. 1). Control is passed to operation 205 and process 200 continues.

Using the methods and systems described herein content may be targeted to recipients of messages distributed by social media publishing. A system is described whereby tracking data is distributed to providers of information which may be associated with a user. If a user activates an indicator distributed by a publisher, tracking data is obtained. A profile of a user may be determined based on tracking data available from various information providers and/or websites. A profile of a publisher may be determined based on tracking data of users. If a user is associated with a targeting parameter, a profile of a publisher may be modified to reflect the targeting parameter. Statistical analysis of users and targeting parameters may determine a profile of a publisher.

An advertiser may provide content directed to a targeting profile or group of targeting parameters. An advertiser may direct content to parameters such as geographic, demographic, topical interests, affiliations, etc. A publisher profile may be used to rank content provided to a publisher. If content ranks highly for a publisher profile, the content may be more likely to be presented to a publisher. If content ranks highly for a publisher views of content influenced by a publisher may have a higher compensation.

A user profile may be used for various purposes. A user may receive different content based on a user profile. For example, if a user has a high ranking for a location, content targeted to a location may be presented to a user. Similarly, content might be differentiated based on demographics. If a content message distributed by a publisher indicates a generic type of content, a user profile might differentiate the content provided when a user activated an indicator of the content message. For example, a generic advertisement for a national chain of stores might be distributed by a publisher, and a local advertisement for a particular store associated with a user profile might be provided. Likewise, gender, age, spending habits, viewing habits, etc. might influence a type of content provided to a user.

While the system is described in the context of internet distribution of advertising, any system in which promotional content is distributed to anonymous users through an undifferentiated channel might take advantage of the benefits of the embodiments described herein.

In systems wherein questions are asked by users and answers are provided by paid answerer and/or peer answerers, it is common to re-publish user questions and answers. This activity may help to defray the cost of providing a response, and may allow other users to view entertaining content. Companies such as Answers and ChaCha have used this republication strategy to good effect.

Re-publication of questions and answers may be interesting, but is often not as effective at obtaining and retaining user attention as it might be. For example, a user may see a question which matches his interest from a web search engine such as the Google or Bing® search systems. But if a user visits the page and there is not additional content which is of interest, the user may not remain on the site. Likewise, a search engine may give a low ranking to websites which republish questions due to the sparseness of the content and/or the higher ranking given to websites with a larger and/or richer corpus of content such as Wikipedia, or WebMD. This despite the fact that a user may be required to spend a larger amount of time locating desired information.

A weakness for question and answer republication is that user questions may not be of general interest, and thus not attract a large amount of traffic. User questions on a given topic may be very similar to each other, or may be unrelated. As a consequence, questions which may appear related based on automated analysis may be unrelated, and questions which appear to be different but related may in fact be unrelated. Consequently a user experience may be degraded despite the availability of good answers to questions.

An alternative approach to content creation is that of About wherein editors are selected to publish on topics, and a type of Darwinian selection is used to eliminate duplication of effort. Such a system requires a network of writers, editors, etc., as further described in U.S. Pat. No. 6,336,132 issued to Appleman. However, the system of Appleman has weaknesses as well. Redundant publication by different publishers may occur and editors' revenue may be unpredictable and slow to increase.

For these and other reasons, a method and system creating a work of authorship based on activities of multiple authors would be greatly appreciated.

A system is implemented whereby a work of authorship may be created is provided. A website server acts as a repository of web pages which may be published. An editor system may select a topic on any suitable basis, and may compose questions or topics for distribution. A server allows the editor system to direct questions relating to the topic to a number of answerers or writers located at responder systems. Answers to questions are returned to the server, and may be reviewed and/or augmented.

An editor may use various methods to compose a finished work. Answers may include an image which is selected by an answerer. An image may be selected based on a classification of a question, and/or based on an answer, an answerer, etc. An editor may review an answer to determine whether the answer will be used in a work. An editor may direct questions to answerers based on a ranking of answerers for a topic and/or content of a question. Questions may be distributed using automated routing and/or human assistance. An answerer may be selected based on a profile of an answerer. For example, opposing viewpoints on a subjective question might be obtained, or a restaurant preference might be obtained based on age, gender, economic, etc., profiles of an answerer. Content presented may be affected by a profile of an answerer and/or a location associated with a topic or a request or query or question. For example, an advertisement might be presented when a topic or question associated with a location targeted by an advertisement is presented. Likewise, an answer or response may be provided based on a location, and/or related content such as images, works, etc., may be differentiated based on profile information of a user, an answerer, etc.

Questions or requests may be provided in any order to answerers. In an embodiment, an answerer may receive a limited number of questions, and questions may be distributed in order that the questions are answered as rapidly as possible. In an embodiment, other works relating to the topic may be indicated on a web page including the work. For example, if a person is a topic of a work, indicators of works for which related persons are the topic may be provided.

Topics or themes may be selected based on various criteria. A topic may be selected based on usage in a corpus such as Twitter activities, a news feed, trending keywords in search queries on a search engine, etc. For example, frequent and/or recent usage of a “hash tag” or named entity may cause that information to be provided to an editor for composition of question or requests. An editor may be provided with lists of related questions to a topic, and a ranking of a topic may be affected by a number and/or timeliness of questions relating to the topic. For example, if a sports team's name appears as a ‘trending’ topic and questions and answers obtained from a database relating to that team are associated with older date stamps new questions may be distributed to answerers to refresh the content available regarding that team.

A system is provided which includes an editor system for obtaining a topic or subject matter and submitting requests or questions, a distribution system receiving and distributing topics, requests, responses, advertisements, information and/or content, a database storing information of editors, responders, advertisers, advertisements, publishers, and other information, a website system receiving information and publishing content, responder systems receiving requests and providing responses and advertiser systems providing sponsored content and targeting information.

A “user” is a person who submits a request and may receive any type of information responsive to a request. A user may be any person or entity. A “publisher” is any person or entity which may distribute content to a user responsive to requests. A publisher may distribute content including advertisements. Content of a publisher may be accessible via any suitable communication medium such as Internet Protocol (IP), voice, text (e.g., SMS), social media, etc. A publisher may distribute content via an application or “App” and/or a browser functionality of a user device.

An “advertiser” is any person and/or entity which may provide promotional information or “advertisements” to be delivered. An advertisement may take various forms and/or may include media of any sort which can be delivered to a user device. An “editor” or coordinator may be any person with access to a publishing system who may elect to create a work. A “responder” or writer or answerer may be any person and/or system which may elect to receive a request and provide a response.

An editor may receive information of a topic in any manner. An editor may be provided with topics based on information provided by a publishing system. An editor may have an area of interest. A profile of an editor may be maintained which may be used to select content which is provided when a work produced by a group including the editor is presented.

A responder may receive requests in various ways. A responder may elect to receive requests based on one or more categories, keywords or topics assigned to a responder. Profile information associated with a responder may be used to determine when a request is directed to a responder. A ranking of a responder may affect whether a request is directed to a responder. An editor may select a responder to whom a request is directed.

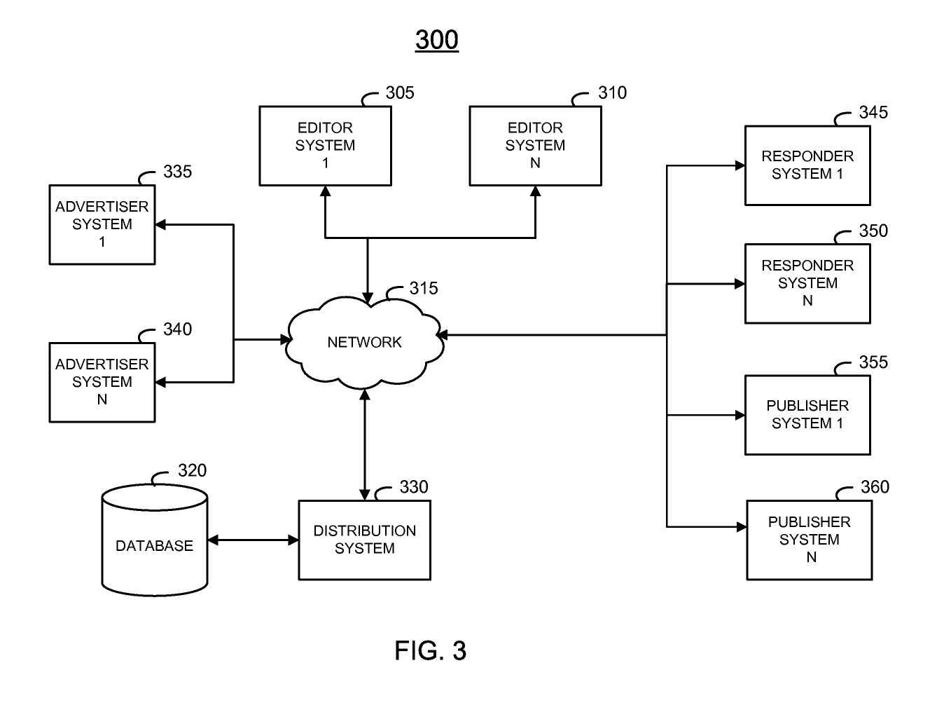

As illustrated in FIG. 3, system 300 includes editor systems 305, 310, a network 315 such as the Internet, a distribution system 330, a database 320, which may comprise various records, advertiser systems 335, 340, responder systems 345, 350, and publisher systems 355, 360. An editor system and/or a responder system may be operated by a user.

While only a few systems associated with an editor, a publisher, a responder and an advertiser are depicted in FIG. 3 it is within the scope of the disclosure for multiple systems for an editor, a publisher, a responder and/or an advertiser to be utilized. In particular it is envisioned that many editor, publisher, responder and advertiser systems may be implemented. The distribution system 330 may be a composed of many components as described further herein.

The network 315 may be a global public network of networks (i.e., the Internet) and/or may consist in whole or in part of one or more private networks and communicatively couples the editor systems 305, 310, the advertiser systems 335, 340, the responder systems 345, 350 and the publisher systems 355, 360 with the other components of the system such as the distribution system 330, and the database 320. The network 315 may include one or more wireless networks which may enable wireless communication between the various elements of the system 300. For example, the distribution system 330 may receive messages which may be routed via a wireless network controlled by a wireless service to the editor systems 305, 310. A wireless service may receive messages from the responder systems 345, 350 via a wireless network which is a part of the network 315, and provide the messages to the distribution system 330 via an internet connection which is part of the network 315.

The distribution system 330 allows interaction to occur among the editor systems 305, 310, the advertiser systems 335, 340, the responder systems 345, 350 and the publisher systems 355, 360. For example, a request can be transmitted from the editor system 305 to the distribution system 330, which may provide information obtained from the database 320, which may include an advertisement provided by the advertiser system 340 to the responder system 345. Any type of communication between users, editors, responders, advertisers, and/or publishers may be mediated and/or facilitated by the distribution system 330, and/or other elements of the system 300.

The distribution system 330 is communicatively coupled with the database 320. As will be described herein in further detail below, the database 320 includes data that is processed in association with operation of the embodiments. Although FIG. 3 illustrates the database 320 as a separate component of the system, the database 320 may be integrated with the distribution system 330. Further, the records maintained in the database 320 may be stored in any typical manner, including in a Network Attached Storage (NAS), a Storage Area Network (SAN), RAID, etc., using any typical or proprietary database software such as DB2®, Informix®, Microsoft® SQLServer™, MySQL®, Oracle®, etc., and may also be a distributed database on more than one server. Elements of the database 320 may reside in any suitable elements of the system 300. Any or all elements of the system 300 may include any or the entirety of the database 320.

The editor systems 305, 310, the advertiser systems 335, 340, the responder systems 345, 350, the publisher systems 355, 360 and the distribution system 330 may include equipment, software, systems and personnel required to send and/or receive messages between the editor systems 305, 310, the advertiser systems 335, 340, the responder systems 345, 350 the publisher systems 355, 360 and/or the distribution system 330 using the network 315. The database 320 includes information which may allow the distribution system 330 to establish communication between any or all of the elements of the system 300.

An editor system, a publisher system, an advertiser system, a responder system and/or a distribution system may be a desktop, portable, or tablet computer using an operating system such as Windows®, iOS®, Android®, etc., a mobile phone, a smart phone, a PDA, a server system, a landline phone, a specialized communication terminal, a terminal connected to a mainframe, or any other suitable communication hardware and/or system. The distribution system 330, a database, an advertiser system, and/or a publisher system may include one or more servers, computers, etc. For example, servers such as the PowerEdge® 2900 by Dell, or the BladeCenterJS22 by IBM, or equivalent systems might be used to implement elements of the distribution system 330. The distribution system 330 may utilize an operating system (OS) such as Microsoft Windows XP, Linux, iOS®, Android®, etc. Voice routing and packet switching may be accomplished using well established technologies such as those provided by Cisco, or other networking companies. After being presented with the disclosure herein, one of ordinary skill in the relevant art will immediately realize that any viable computer systems or communication devices known in the art may be used as user systems, publisher systems, advertiser systems, responder systems and/or to implement the distribution system 330.

An editor may be identified by the distribution system 330. When an editor system accesses the distribution system 330 an editor may be identified based on security information provided to the distribution system 330. An editor may obtain information regarding topics for which an editor may elect to create a work. An editor may receive responses based on a number of requests composed by an editor. An editor may receive media associated with a work such as videos, images, text, audio, interactive media, etc. An editor may modify a work in various ways such as removing, adding, modifying, and otherwise managing content of a work.

An editor may be required to register with the distribution system 330. As part of a registration process, at least one communication method is associated with an editor. In at least one embodiment, an editor may register with the distribution system 330 and establish a username and password which are associated with the editor. An editor may login to the distribution system 330 using a web browser functionality of the editor system 310 in order to communicate with the distribution system 330. One or more identifiers may be assigned to an editor and may be used to identify content associated with an editor. An editor may provide profile information such as personal information, geographic, background, affiliation, demographic, interest, category, etc. information. An editor may provide information required to provide payment to an editor. An editor may access the distribution system 330 via an applet or “App” resident on a device associated with an editor.

When an editor is registered with the distribution system 330 the editor may have access to content available from the distribution system 330. This may include sponsored content provided by the advertiser systems 335, 340, data indicated in the database 320, responses of responders, topics, etc. An editor may have access privileges based on factors such as experience of the editor, ratings of works by an editor, revenue obtained based on works of an editor, etc.

A responder may be required to register with the distribution system 330. As part of a registration process, at least one communication method is associated with a responder. In at least one embodiment, a responder may register with the distribution system 330 and establish a username and password which are associated with the responder. A responder may login to the distribution system 330 using a web browser functionality of the responder system 345 in order to communicate with the distribution system 330. One or more identifiers may be assigned to a responder and may be used to identify content associated with a responder. A responder may provide profile information such as personal information, geographic, background, affiliation, demographic, interest, category, etc. information. A request may be directed to a responder based on any information associated with a responder. A responder may elect to block requests based on factors such as content, originator, etc. A responder may provide information required to provide payment to a responder. A responder may be affiliated with an editor. For example, an editor may recruit a responder.

When a responder is registered with the distribution system 330 the responder may have access to content available from the distribution system 330. This may include sponsored content provided by the advertiser systems 335, 340, data indicated in the database 320, requests of editors, topics, etc. A responder may have access privileges based on factors such as experience of the responder, ratings of responses of a responder, revenue obtained based on works of a responder, editor affiliation of a responder, etc.

A publisher may be required to register with the distribution system 330. As part of a registration process, at least one communication method is associated with a publisher. In at least one embodiment, a publisher may register with the distribution system 330 and establish a username and password which are associated with the publisher. A publisher may login to the distribution system 330 using a web browser functionality of the publisher system 355 in order to communicate with the distribution system 330. One or more identifiers may be assigned to a publisher which may be used to distribute content such as works, advertisements, images, etc., to a publisher.

When a publisher is registered with the distribution system 330 a publisher may have access to data available from the distribution system 330. This may include content produced by an editor and/or responder, advertisements, information of responders, editors, users, etc. A publisher may provide information of users to the distribution system 330 and/or may receive advertisements targeted based on targeting information provided by the distribution system 330. A publisher may provide information regarding unique users, user activities, etc., associated with content to the distribution system 330. A publisher may make content available in any suitable manner. For example social media, web based publishing, email distribution, printed media and/or other forms of media distribution might be employed by a publisher.

An advertiser may be required to register with the distribution system 330. As part of a registration process, at least one communication method is associated with an advertiser. In at least one embodiment, an advertiser may register with the distribution system 330 and establish a username and password which are associated with the advertiser. An advertiser may login to the distribution system 330 using a web browser functionality of the advertiser system 335 in order to communicate with the distribution system 330. An advertiser system may provide content and may associate targeting information with content.

When an advertiser is registered with the distribution system 330 an advertiser may have access to data available from the distribution system 330. This may include targeting information associated with publishers, content, responders, editors, use of advertisements, compensation associated with advertisements, available targeting information, etc. An advertiser may target advertisements based on any available targeting parameters. An advertiser may provide content associated with a targeting parameter which may be distributed based on targeting information associated with works.

Records may be maintained in the database 320 which may be used to record the status of various items. Such records may be used to aid the targeting of content provided by advertisers, track activities of users, determine usage history of websites, publisher content, and advertisements, etc. For example, a user may activate an indicator distributed by a publisher, which may cause a request to be received by the distribution system 330, which may obtain activity information which may be used to select content to be provided to a user responsive to a request. Similarly, the database 320 may include records of activities of editors and responders regarding production of works.

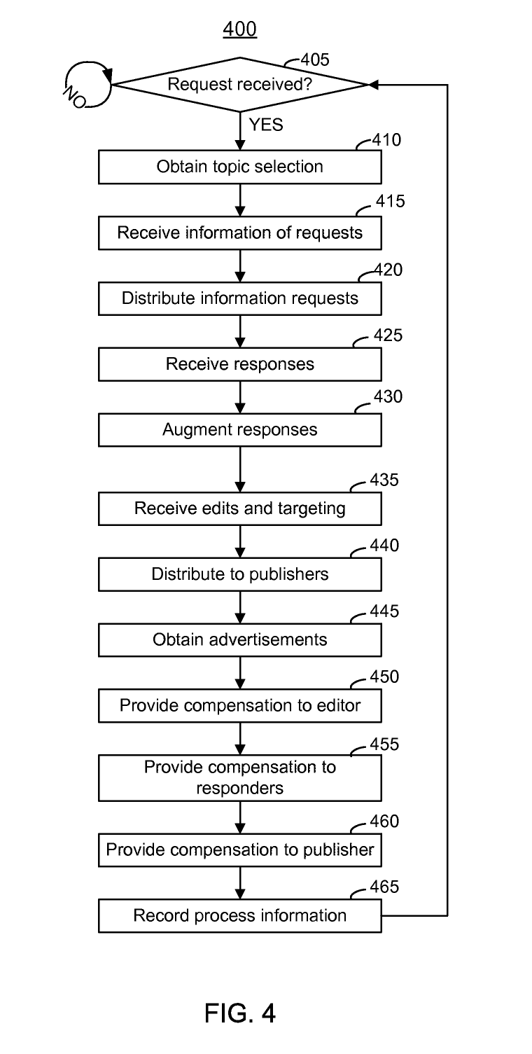

As illustrated in FIG. 4, a process 400 for creating a work is provided. The process 400 may be performed in whole or in part by any suitable element of the system 300 (FIG. 3). In at least one embodiment, the process 400 is operative on a server associated with the distributor system 330.

In operation 405 (FIG. 4) a determination is made as to whether a request is received. If it is determined in operation 405 that a request is not received, control remains at operation 405 and process 400 continues. If it is determined in operation 405 that a request is received, control is passed to operation 410 and process 400 continues.

The determination in operation 405 may be made using various criteria. In at least one embodiment, if a message is received at a system associated with the distribution system 330 (FIG. 1), it may be determined that a request is received. For example, if a GET request indicating an identifier of an editor is received at a server associated with the distribution system 330, it may be determined that a request is received. Any type of message may be received which may indicate that a request is received. For example, reception of an SMS message, a mobile web message, a message from an App, etc., may be used to determine whether a request is received.

In operation 410 a topic selection is obtained. A selection of a topic may be received from an editor. A selection of a topic may be based on a list of topics provided to an editor. A selection of a topic may be determined automatically. For example, if an editor is associated with a category and a topic is a highest ranking topic for the category, the topic may be selected. Any suitable criteria may be used to select a topic. Control is passed to operation 415 and process 400 continues.

In operation 415, information of requests is received. An editor may compose a number of requests based on a topic. An editor may identify a number of responses and/or targeting information associated with a request. For example, an editor may determine that a request is for factual information and requires a single response. An editor may elect to direct a request to responders associated with a characteristic. For example, an editor may request a response from a responder based on gender, age, location, ranking, skills, etc. Control is passed to operation 420 and process 400 continues.

In operation 420 requests are distributed. Requests may be distributed according to any suitable criteria. For example, requests may be distributed to responders as responders become available. Requests may be distributed based on a ranking of a responder for a request. For example, a highest ranking responder for a topic of a request, or a responder located in a place identified by a request, or a responder ranked highest for a targeting parameter of a request may be more likely to receive a request. Requests within a group of requests may be distributed to unique responders. For example, a number of responders may be determined based on a deadline for submission of a work for publication. Responders with an affiliation may receive preference in distribution of a request. For example, responders within a network shared with an editor may be more likely to receive a request. Control is passed to operation 425 and process 400 continues.

In operation 425 responses are received. Any number of responses may be received. Any request in a group of requests may receive any number of responses. A number of responses and/or a number of requests receiving responses may be evaluated. Responses may be received from any device associated with a responder. Control is passed to operation 430 and process 400 continues.

In operation 430 responses are augmented. In at least one embodiment, augmentation may not occur. Augmentation may be assisted by an editor, a responder, and/or automated means. For example, an image associated with a request and/or a response may be selected based on content of a request, or related content may be associated with a request based on a topic, and/or targeting information of a request and/or response. A responder may augment a response of a different responder. An editor may augment responses and/or requests. Augmentation may include any type of media such as audio, video, text, graphics, metadata, information of an editor, responder, etc. Control is passed to operation 435 and process 400 continues.

In operation 435 edits and targeting are received. A person such as an editor may review requests and/or responses associated with requests, and may edit responses, requests and/or augmentations. Targeting information may be determined based on factors such as a topic, a keyword, a location, affiliation, demographics, geographic, and/or other parameters identified and/or associated with requests, responses, editors, responders, augmentations, etc. of a work. Control is passed to operation 440 and process 400 continues.

In operation 440, content is distributed to publishers. Content may be distributed using any suitable delivery system and/or media. Content may be distributed as Html, Java scripts, text, images, etc. which can be delivered responsive to a user request. Content may be distributed in a format suitable for use by a smartphone or tablet App. Content may be distributed based on a request of a publisher. Control is passed to operation 445 and process 400 continues.

In operation 445 advertisements are obtained. Advertisements may be obtained from advertisers such as the advertiser system 340 (FIG. 3). Advertisements may be obtained by the distribution system 330 and may be delivered to a publisher system such as the publisher system 355. Advertisements may be targeted based on attributes of a user accessing a publisher system and/or targeting parameters determined by content distributed by the distribution system. Control is passed to operation 450 and process 400 continues.

In operation 450, compensation is provided to an editor. Compensation of an editor may not include financial compensation. For example, an editor may receive recognition rather than financial reward. Compensation of an editor may be based on advertising revenue associated with a work associated with an editor. Compensation of an editor may be based on a type and/or amount of work performed by an editor. An editor may receive compensation based on a number of times a work is viewed. An editor may be ranked and/or rated based on a number of times a work is viewed, a number of times a page of a work is viewed, time and manpower required to create a work, cost of content incorporated in a work, etc. A rating of an editor may affect compensation provided to an editor. Control is passed to operation 455 and process 400 continues.

In operation 455, compensation is provided to responders. Compensation of a responder may include be financial or extrinsic compensation. For example, a responder may receive recognition rather than financial reward. Compensation of a responder may be based on advertising revenue associated with a work associated with a responder. Compensation of a responder may be based on a type and/or amount of work performed by a responder. For example, a responder may receive a flat fee for a response accepted by an editor. A responder may receive compensation based on a number of times a work was viewed. A responder may be ranked and/or rated based on a number of times a work is viewed, a number of times a page of a work is viewed, a number of times a response of a responder is rejected by an editor, etc. A rating of a responder by an editor may affect compensation provided to a responder. Control is passed to operation 460 and process 400 continues.

In operation 460, compensation is provided to publishers. Compensation of a publisher may include financial and/or intrinsic compensation. For example, a publisher may receive recognition, higher ranking in search results, etc., rather than financial reward. Compensation of a publisher may be based on advertising revenue. Compensation of a responder may be based on a type of user attracted by a publisher. A publisher may be compensated based on a number of times content is viewed viewed (CPM), a number of content elements activated (CPC), actions by users (CPA), etc. Control is passed to operation 465 and process 400 continues.

In operation 465, process information is recorded. Information of a request, a user, an editor, a responder, a publisher, a website, an advertiser, content, targeting parameters, user actions, compensation of a publisher, responder, editor, advertiser, etc., a rating, a ranking, etc. may be recorded. In at least one embodiment, process information is recorded in the database 320 (FIG. 3). Control is passed to operation 405 and process 400 continues.

A system and method of creating a work of authorship using multiple authors is described. A topic is selected by an editor, requests for responses are sent to responders, and responses are aggregated, augmented, and edited. Targeting information is associated with requests and responses and a composite work is published.

Using the methods and systems described herein a work may be created. A work may be created based on a topic which is selected. A selection of a topic may be controlled automatically and/or may be based on an action of an editor. An editor may create a number of requests which may be distributed to responders. A responder may compose a response based on a request received by a responder. Requests and responses related to a topic may be collected. A group of requests and/or responses may be reviewed by an editor. A request and/or a response may be augmented automatically and/or using the assistance of a person such as an editor or responder. A library of media which may be used to augment responses and/or requests may be provided. A group of requests and/or responses may be distributed to publishers. A group of requests and/or responses may be associated with targeting information which may be used to select content which may be published with a group of requests and/or responses.

A request may be directed to a responder based on various criteria. Responders may elect to register for and/or provide targeting information which may be used to direct requests to responders. A responder may be assigned a rating and/or ranking associated with targeting information. A rating of a responder for a targeting parameter may be based on acceptance of a response of a responder by an editor. Targeting parameters may include topics, categories, keywords, geographic, demographic, affiliation, personality, etc. traits associated with responders and/or editors. Content of a work distributed to a publisher may be determined by targeting parameters. A work may be customized for a demographic, a location, and/or an affiliation based on targeting parameters which may be supplied by a publisher. For example, a work may include content based on an age group, a gender, a city, etc.

Content published in association with a work may include advertisements. Advertisements may be determined based on targeting parameters associated with a work and/or a publisher. Compensation for an editor, a responder, a publisher, and a distribution service may be monetary or non-monetary. Compensation may be determined based on revenues received for advertisements published in association with a work. An editor, a responder, and/or a publisher may receive compensation based on activities performed.

While the system and method described herein have been disclosed in the context of a content distribution network no limitation is implied thereby. A work might be composed by any system which can be implemented using collaborative authorship. For example, academic works, wiki pages, instruction manuals, and/or any type of work of authorship might be created using the systems and methods described herein.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal. Further, according to an aspect of the embodiments, any combinations of the described features, functions and/or operations can be provided.

The many features and advantages of the claimed invention are apparent from the detailed specification and thus, it is intended by the appended claims to cover all such features and advantages of the claimed invention that fall within the true spirit and scope of the invention. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope of the claimed invention. It will further be understood that the phrase “at least one of A, B and C” may be used herein as an alternative expression that means “one or more of A, B and C.”

What is claimed is:

1. A computer-implemented process comprising:
distributing data to a user responsive to a request;
providing an identifier to a publisher;
receiving, by a processor, a message indicating the publisher; and
determining targeting parameters of the publisher based on the data.

2. The method of claim 1 further comprising:
providing the data as a browser cookie.

3. The method of claim 1 further comprising:
providing the data based on content indicated by the request.

4. The method of claim 1 further comprising:
obtaining the data responsive to the message when the user is directed to content based on access information provided by the publisher.

5. The method of claim 1 further comprising:
determining relevance of the user to content provided by the publisher based on the data.

6. The method of claim 1 further comprising:
providing content to the user based on the data and the message.

7. The method of claim 1 further comprising:
procuring a bid to provide content to the user based on the data.

8. The method of claim 1 further comprising:
ranking the publisher based on the data; and
providing content to the publisher based on the ranking and the message.

9. The method of claim 8 further comprising:
receiving messages indicating publishers; and
ranking the publishers based on a correlation of the data to the content.

10. The method of claim 1 further comprising:
ranking the publisher based on the data and a count of messages received indicating the publisher and identifying content correlated to the data.

11. The method of claim 1 further comprising:
ranking content based on the targeting parameters; and
offering the content to the publisher passed on the ranking.

12. The method of claim 1 further comprising:
increasing a rating of the publisher based on whether historical data of the user is provided.

13. The method of claim 1 further comprising:
identifying a topic of a work which is to be created;
receiving a query from an editor based on the topic;
distributing the query to a responder; and
delivering the work comprising the query and a response of the responder to a publisher selected based on the data and corresponding parameters of the editor and the responder.

14. A non-transitory computer readable storage medium storing therein an instruction for causing a computer to execute an operation, comprising:
distributing data to a user responsive to a request;
providing an identifier to a publisher;
receiving a message indicating the publisher; and
determining targeting parameters of the publisher based on the data.

15. A system comprising:
a user device submitting a request and receiving data; and
a distribution system device comprising memory and a processor providing an identifier to a publisher, receiving a message indicating the publisher, and determining targeting parameters of the publisher based on the data.

16. The system of claim 15 further comprising:
a publisher device receiving the identifier, selecting content to be distributed, and distributing the content to the user.

17. The system of claim 15 further comprising:
a server device receiving a message from the user device and providing content comprising the data to the user device.

18. The system of claim 15 further comprising:
the distribution system device receiving the data from the user device, determining a number of users associated with a publisher which have provided the data, and determining a value of the targeting parameter based on the number of users.

19. The system of claim 15 further comprising:
the distribution system device ranking the publisher based on a number of users associated with the publisher which provide the data when submitting a request to the distribution system device and selecting content which is provided to the publisher based on the ranking.

20. The system of claim 15 further comprising:
the distribution system device determining whether the data indicates that a publisher has successfully delivered content to users associated with a targeting parameter and selecting media to be delivered to a user responsive to the request which is broadly targeted by the message and specifically targeted by the data.
